(19) United States
(12) Patent Application Publication
(10) Pub. No.: US 2010/0094758 A1
(43) Pub. Date: Apr. 15, 2010

(54) SYSTEMS AND METHODS FOR PROVIDING REAL TIME ANONYMIZED MARKETING INFORMATION

(75) Inventors: Simon Chamberlain, Albert Park (AU); Andrew Lientz, Culver City, CA (US); Brian Stack, Irvine, CA (US)

Correspondence Address: KNOBBE MARTENS OLSON & BEAR LLP, 2040 MAIN STREET, FOURTEENTH FLOOR, IRVINE, CA, 92614, US

(73) Assignee: EXPERIAN MARKETING SOLUTIONS, INC., Schaumburg, IL (US)

(21) Appl. No.: 12/576,194

(22) Filed: Oct. 8, 2009

Related U.S. Application Data
(60) Provisional application No. 61/105,012, filed on Oct. 13, 2008.

(51) Int. Cl. G06Q 10/00; H04L 9/28; G06Q 30/00; H04L 9/14

(52) U.S. Cl. 705/50; 705/10; 713/162

(57) ABSTRACT

Embodiments disclosed herein are directed to systems and methods for enabling the matching of third party data with access providers' subscriber data in a privacy compliant manner, and then connecting an internet user to that third party data for use by marketers, content providers, or other interested parties in a manner that protects consumer privacy at all times. In one embodiment, an access provider such as an ISP sends its subscriber data to a double blind processor that generates an encrypted key for each subscriber. The key is then used to find matching consumer data, for example, consumer segments that represent previously collected or modeled consumer attitudinal, habit, or financial data. The key may be forwarded to a real time marketing bureau, which may use the matched data in subsequent real-time or substantially real-time operations to provide consumer or business data to advertisers, content providers, and other interested parties.

### CROSS-REFERENCE TO RELATED APPLICATIONS

This application is based upon and claims the benefit of priority from U.S. Provisional Patent Application No. 61/105,012 filed on Oct. 13, 2008, entitled “Systems and Methods for Providing Real Time Anonymized Marketing Information,” the entire contents of which are hereby incorporated herein by reference in their entirety. All publications and patent applications mentioned in this specification are herein incorporated by reference in their entirety to the same extent as if each individual publication or patent application was specifically and individually indicated to be incorporated by reference.

### BACKGROUND

1. Field

This disclosure relates in general to computer data processing, and in particular to computer based systems and methods for providing anonymized marketing information.

2. Description of the Related Art

In recent years, many network/content access providers (e.g., Internet Service Providers (ISPs), Multi-System Operators (MSOs), IPTV Operators, Mobile Operators, Telecommunication Companies, Web Portals, etc.), in an effort to boost revenues, have become interested in how they can monetize their subscriber data. Concerns over consumer privacy and fair data usage have slowed the expansion of these revenue opportunities and in some cases, have prompted regulatory agencies and legislative bodies into investigating the practice and reviewing the laws and regulations regarding use of such data.

### SUMMARY OF THE DISCLOSURE

Embodiments disclosed herein are directed to systems and methods for enabling the matching of third party data with access providers' subscriber data in a privacy compliant manner, and then connecting an internet user to that third party data for use by marketers, content providers, or other interested parties in a manner that protects consumer privacy. In one embodiment, an access provider such as an ISP or a content provider such as a web portal sends its subscriber data to a double blind processor that generates an encrypted key for each subscriber. The key is then used to find matching consumer data, for example, consumer segments that represent previously collected or modeled consumer attitudinal, habit, and/or financial data. As an example, a “segment” can also be a raw data element (e.g. known household composition/number of people in household), a modeled element (e.g. estimated household composition), a modeled segment built upon raw data elements, or a custom segment. In one embodiment, identifiers of the matched consumer segments, if found, are appended to the encrypted keys for respective subscribers. In other embodiments, where the subscriber may be a business, the encrypted key is used to locate matching data related to the business. Matching is not limited to consumer or business segments and other types of consumer or business data may be used.

In another embodiment, an access provider such as an ISP or a content provider such as a web portal can submit its subscriber data to a marketing data appliance (MDA) located within its network. Although the term “access provider” or “network access provider” is used herein, embodiments disclosed herein may operate in conjunction with content providers such as web portals. The MDA uses the personally identifiable data within the subscriber data to find matching consumer or business data, for example, consumer or business segments that represent previously collected or modeled consumer attitudinal, habit, and/or financial data. In one embodiment, the MDA strips out personally identifiable data and forwards the matched data to a real time marketing bureau (RTMB). The RTMB uses the matched data in subsequent operations to provide consumer or business data to advertisers, content providers, and other interested parties. For example, when a subscriber of the access provider (e.g. ISP) accesses a web site, the web site may trigger a request to the RTMB, which in turn may return anonymized marketing data associated with the subscriber to the web site. The returned anonymized data may include previously matched consumer segments associated with the subscriber as discussed above, which may be used by the web site to customize content to be displayed to the subscriber. In one embodiment, the access provider may provide to the MDA data indicative of the IP address that is dynamically assigned to the subscriber, along with an identifier of the subscriber, to enable the MDA to provide anonymized marketing data to the RTMB. In one embodiment, the RTMB may provide to the MDA the IP address of the subscriber who is visiting the web site that triggered the request for anonymized marketing data, and the MDA may match the IP address from the RTMB to that which is indicated by the access provider as assigned to the subscriber, in order to determine which subscriber's marketing data should be returned. In one embodiment, because the MDA is located within the same network behind the access provider's firewall and matching is performed based on anonymized identifiers such as encrypted keys and IP addresses, no personally identifiable data is transmitted outside of the access provider's network. This allows the access provider to furnish subscriber data to the RTMB to provide through to Internet marketers, content providers, and/or other interested parties in a way that protects consumer privacy.

In some embodiments, the MDA may contain regularly updated system rules that reflect changing privacy laws and regulations. In other embodiments, the MDA may apply different system rules based on the subscriber address received from the access provider, so that the process is in compliance with any additional local or state laws and regulations. As such, the access provider is saved from having to constantly modify its own system to keep up with changing or additional local laws or regulations. In other embodiments, the MDA may contain a regularly updated opt-out listing provided by or otherwise maintained by an access provider, a consortium of access providers, the entity that provides the MDA, a third party service, and/or a governmental agency. The MDA may thus apply appropriate opt-out rules to ensure that data from consumers who have registered with these opt-out listings are not sent outside of the access provider.

One embodiment is a system for providing anonymized marketing data, the system comprising: a segment data store comprising marketing data segment records associated with a plurality of subscribers of an access provider; a processer that is configured to: receive personally identifiable information of the plurality of subscribers from the access provider; for one or more of the plurality of subscribers, match the personally identifiable information of an individual subscriber to an identifier previously associated with the personally identifiable information, the identifier useable to access data that are associated with the individual subscriber in the segment data store; create encrypted keys based on the matched identifiers; and delete the received personally identifiable information; a marketing data appliance that is configured to receive the encrypted keys and append, to the encrypted keys, one or more consumer segment identifiers for the marketing data segment records associated with the individual subscriber; and a compute cluster system that is configured to: receive the encrypted keys with the appended consumer segment identifiers from the marketing data appliance; receive from a network address allocation server a plurality of data entries indicating network addresses assigned to the subscribers; and return, upon a data request from a bureau server containing a network address of a subscriber accessing a server via the access provider, one or more marketing data segment records from the segment data store to the bureau server.

Another embodiment is a system for providing anonymized marketing data, the system comprising: a segment data store comprising marketing data segment records associated with a plurality of subscribers of an access provider; a marketing data appliance that is configured to: receive personally identifiable information of the plurality of subscribers from the access provider; for one or more of the subscribers, match the personally identifiable information of an individual subscriber to an identifier associated with the personally identifiable information; create an encrypted key based on the matched identifier; append, to the encrypted key, one or more consumer segment identifiers for the marketing data segment records in the segment data store that are associated with the individual subscriber; and delete the received personally identifiable information; and a compute cluster system that is configured to: receive the encrypted keys with the appended consumer segment identifiers from the marketing data appliance; receive from a network address allocation server a plurality of data entries indicating network addresses that are assigned to the subscribers; and return, upon a data request from a bureau server with a network address, one or more marketing data segment records from the segment data store to the bureau server.

Another embodiment is a computer-implemented method of providing anonymized marketing data, the method comprising: receiving personally identifiable information for a plurality of subscribers from a network access provider; returning to the network access provider a plurality of encrypted keys that correspond to the received personally identifiable information, the encrypted keys useable to access data in a segment data store; receiving the returned encrypted keys at a marketing data appliance; for each of the encrypted keys, appending to the encrypted key one or more consumer segment identifiers in the segment data store that match the encrypted key; and forwarding the encrypted keys and the appended consumer segment identifiers to a compute cluster system, the compute cluster system configured to return a plurality of marketing data attributes associated with the consumer segment identifiers in response to a request for the marketing data attributes, wherein the method is executed on one or more computing systems.

Another embodiment is a system for providing anonymized marketing data, comprising: a segment data store comprising marketing data segment records associated with a plurality of customers of a business entity; a marketing data appliance that is configured to: receive personally identifiable information of the plurality of customers from the business entity; for one or more of the customers, match the personally identifiable information of an individual customer to an identifier, the identifier useable to access data in the segment data store; and append to the identifier one or more consumer segment identifiers for the marketing data segment records associated with the individual customer; and a compute cluster system that is configured to: receive the identifiers with the appended consumer segment identifiers from the marketing data appliance; receive from a network address allocation server a plurality of data entries indicating network addresses that are assigned to the customers who are subscribers of an access provider; and return, upon a data request from a bureau server comprising a network address, one or more marketing data segment records from the segment data store to the bureau server.

Another embodiment is a computer-implemented method of providing anonymized marketing data, comprising: receiving personally identifiable information for a plurality of customers from a business entity; for one or more of the plurality of customers, assigning an identifier to an individual customer and appending to the identifier one or more consumer segment identifiers that are associated with the identifier; forwarding the identifiers and the appended consumer segment identifiers to a compute cluster system, the compute cluster system configured to receive network address assignments of the customers from a network access provider; and returning, by the compute cluster system, a plurality of marketing data attributes associated with the consumer segment identifiers when at least one of the customers are accessing, through the network access provider, a server that triggers a request for the marketing data attributes, wherein the method is executed on one or more computing systems.

### BRIEF DESCRIPTION OF THE DRAWINGS

Specific embodiments of the invention will now be described with reference to the following drawings, which are intended to illustrate embodiments of the invention, but not limit the invention:

FIG. 1A is a flowchart illustrating a method of providing anonymized marketing data according to one embodiment;

FIG. 1B is a flowchart illustrating a method of providing anonymized marketing data according to one embodiment;

FIG. 1C is a block diagram illustrating the computing systems involved in the method of providing anonymized marketing data according to one embodiment;

FIG. 2A is a combined block and flow diagram of a real time marketing system according to one embodiment;

FIG. 2B is a combined block and flow diagram of a real time marketing system according to another embodiment;

FIG. 2C is a combined block and flow diagram of a real time marketing system according to another embodiment;

FIG. 3A illustrates an example anonymization process matching in accordance with one embodiment;

FIG. 3B illustrates an example anonymization process matching in accordance with one embodiment;

FIG. 3C illustrates an example anonymization process matching in accordance with one embodiment; and

FIG. 4 shows a general purpose computer implementing the processes described herein in accordance with one embodiment.

### DETAILED DESCRIPTION OF CERTAIN EMBODIMENTS

Embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

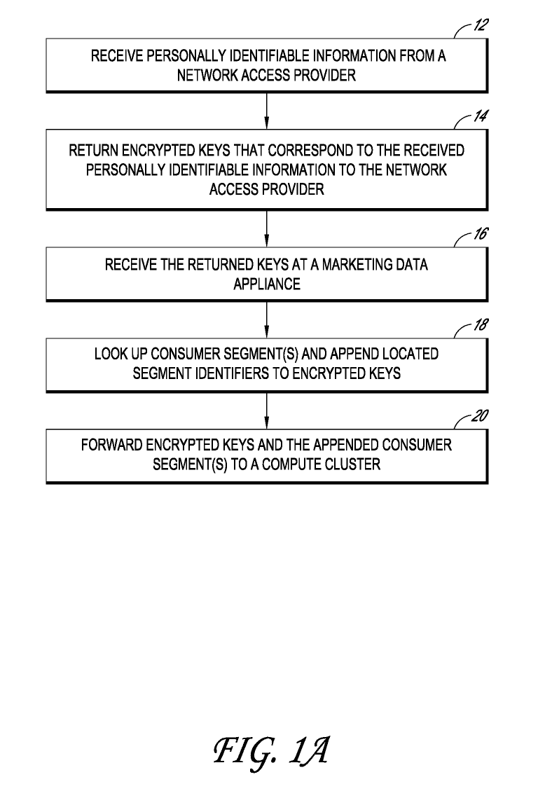

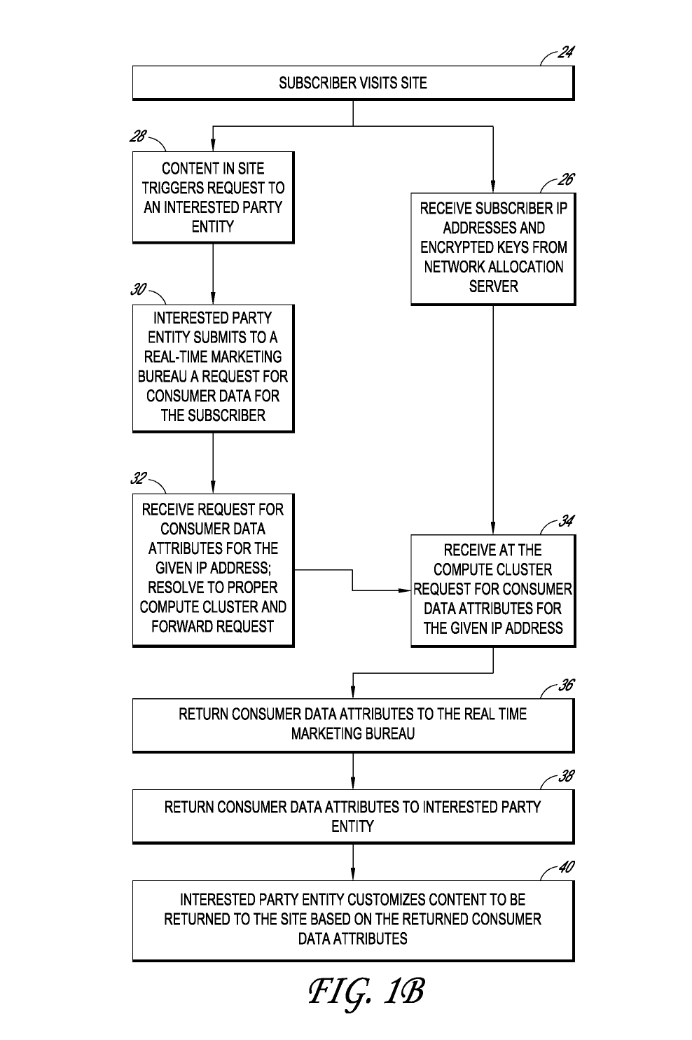

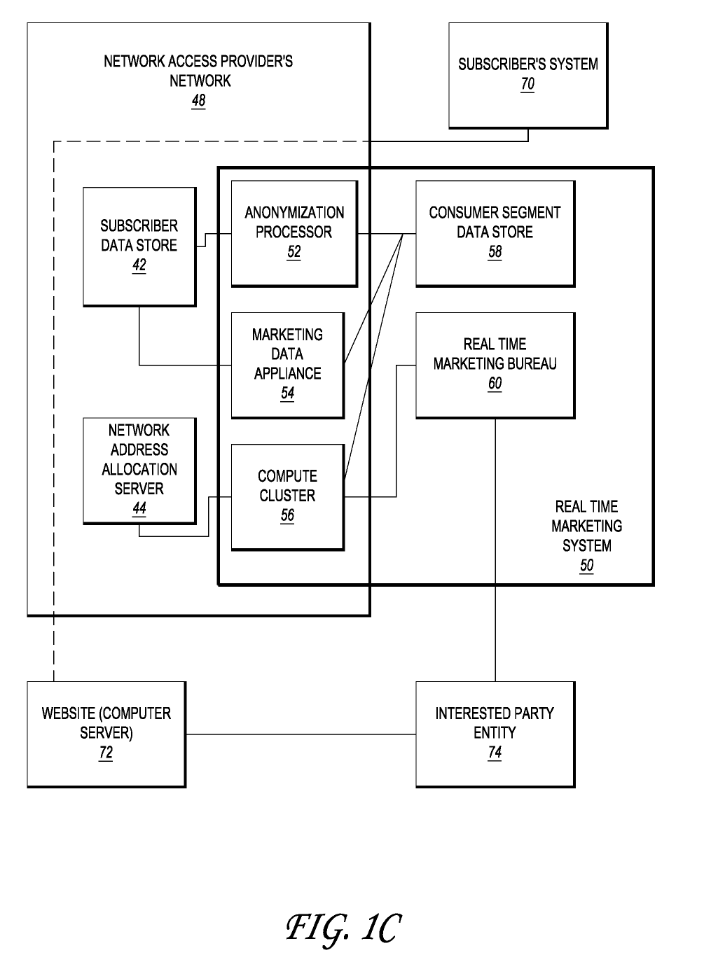

FIGS. 1A and 1B are flowcharts illustrating methods of providing anonymized marketing data according to various embodiments. The methods illustrated in FIGS. 1A and 1B may be executed in the computing systems illustrated in the block diagram of FIG. 1C, including a real time marketing system 50 in accordance with one embodiment. FIG. 1A describes a method of anonymizing subscriber data for subscribers of a network access provider, and associating the anonymized data with consumer segment data useable for marketing purposes. Although the term “network access provider” is used, embodiments disclosed herein may operate in conjunction with content providers such as web portals. With reference to FIG. 1A, at state 12, an anonymization processor may receive personally identifiable information from a network access provider, e.g., from a subscriber data store 42 of the network access provider. At state 14, the anonymization processor 52 may return encrypted keys that correspond to the received personally identifiable information to the network access provider. In one embodiment, the anonymization processor 52 is configured to access a consumer segment data store 58, find an anonymous identifier previously assigned to the person/business identified by the personally identifiable information, encrypt the identifier to create an encrypted key, and return the encrypted key to the network access provider. At state 16, the encrypted keys may be returned by the network access provider to a marketing data appliance 54 within the real time marketing system 50. At state 18, the marketing data appliance 54 may look up consumer segments associated with the encrypted keys by accessing the consumer segment data store 58 and appending located segment identifiers to the received encrypted keys. At state 20, the marketing data appliance 54 may forward the encrypted keys and the appended consumer segment(s) to a compute cluster 56.

In one embodiment, the process described in FIG. 1A prepares for the use of anonymized subscriber data in real time. FIG. 1B describes a method for providing real time marketing data in a manner such that personally identifiable information is not sent outside of the network access provider's network 48. With reference to FIG. 1B, the method begins at state 24 when a subscriber of the network access provider visits a web site, e.g., by the subscriber's computing system 70 accessing, via the network access provider (indicated by the dotted line), a computer server 72 hosing the web site. At state 26, the compute cluster 56 may receive pairing data indicating the subscriber IP addresses associated with the associated encrypted keys from the network access provider (e.g. via a network address allocation server 44). In one embodiment, the network address allocation server 44 accesses the subscriber data store 42 to retrieve the previously assigned encrypted keys (e.g. by the process executed in state 14) and pairs the keys with the IP addresses currently assigned to the subscribers in real time or substantially real time. In one or more embodiments, state 26 may take place before, concurrently with, or after state 24.

At state 28, content in the site 72 visited by the visitor (e.g. an advertisement) may trigger a request to an interested party entity 74, with the request including the subscriber's current IP address in one embodiment. The interested party entity may be an ad network, for example. At state 30, the interested party entity 74 may submit to a real time marketing bureau 60 a request for consumer data attributes for the subscriber, passing along the IP address in one embodiment. In other embodiments, the site 72 may directly send the request for consumer data attributes. At state 32, the real time marketing bureau 60 may then receive the request for consumer data attributes for the given IP address. In one embodiment, the real time marketing bureau 60 may use the IP address to resolve to the proper compute cluster associated with the network access provider to whom the IP address belongs. The proper compute cluster 56 may then receive the request from the real time marketing bureau 60 at state 34.

At state 36, the compute cluster 56 may use the IP address from the request and locate the associated encrypted key and appended segment identifiers. The lookup may use previously supplied IP address-encrypted key pairing information from the network address allocation server 44. The compute cluster 56 may then return the consumer data attributes identified by the segment identifiers to the real time marketing bureau 60. In one embodiment, the compute cluster may access the attributes stored in the consumer segment data store 58. At state 38, the real time marketing bureau 60 may return the consumer data attributes to the interested party entity 74, which may then use the attributes to customize content to be returned to the site at state 40.

Providing Marketing Information Based on Data Supplied by an Access Provider with Double Blind Processing

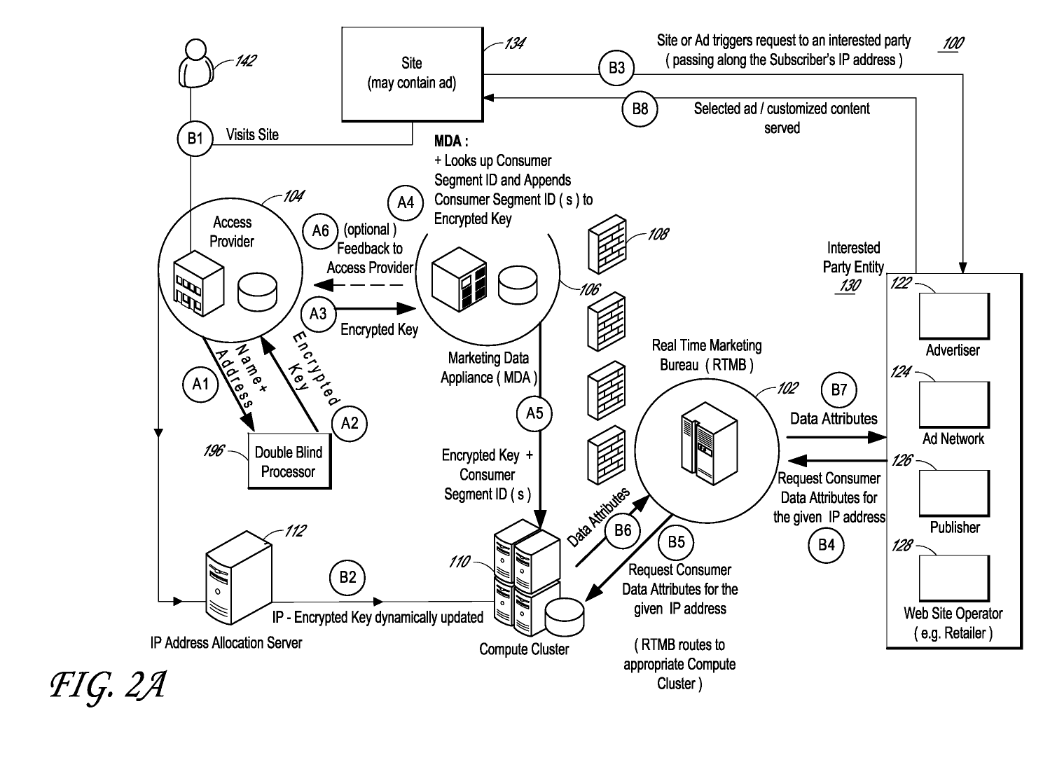

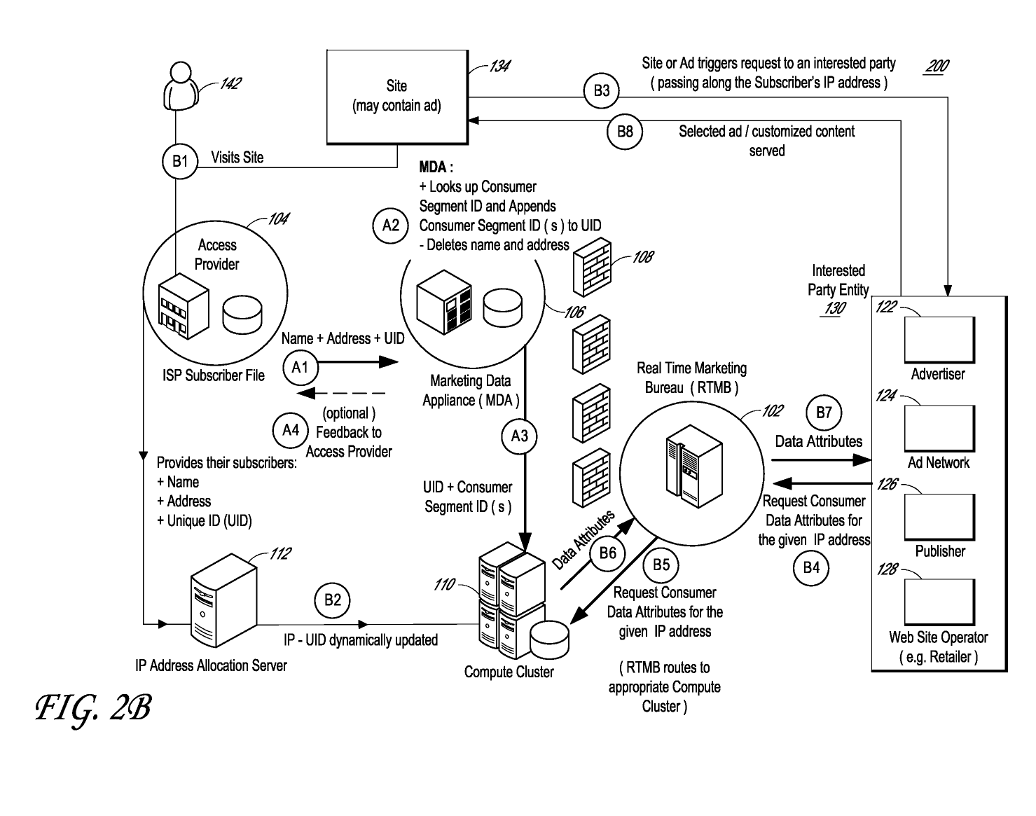

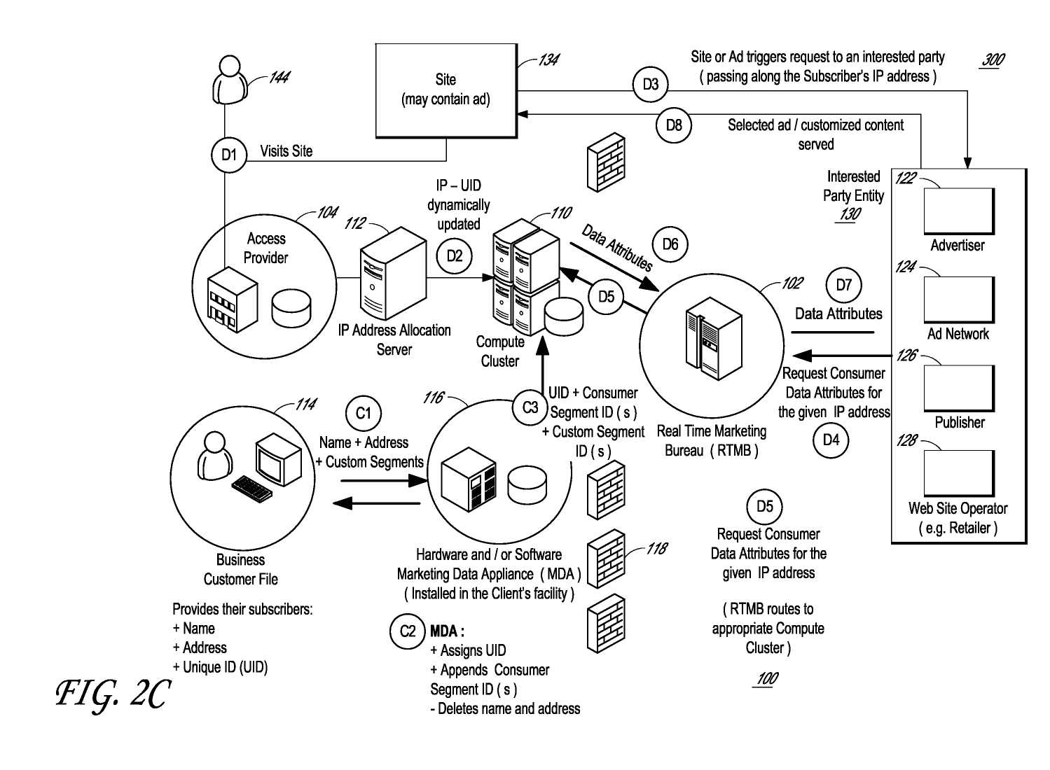

In the embodiment of FIG. 2A, a sample temporal flow of data is indicated by the circled numerals A1-A6 and B1-B8 and is described in further detail below. The “A” steps describe preparatory steps used to enable real time or substantially real time supply of anonymized marketing data and the “B” steps describe steps taken in real time or substantially real time to supply anonymized marketing data. Depending on the embodiment, certain steps may be removed and additional steps may be added.

FIG. 2A is a combined block and flow diagram of a real time marketing system (RTMS) 100 according to one embodiment. At step A1, an access provider 104 provides subscriber data to a double blind processor 196. Subscriber data may include, e.g., for each subscriber, the subscriber's name, the subscriber's address, a Unique ID (UID) assigned to the subscriber, and/or other personally identifiable information (PII) associated with the subscriber. P11 may include, but is not limited to, name, address, email address, and subscriber ID. The double blind processor 196 may be coupled to the same local area network as the access provider and behind a common firewall 108, as shown. In other embodiments, the double blind processor 196 may be coupled to a network outside of the access provider's network and the access provider 104 may transmit subscriber data to the double blind processor 196 over a secure connection. The double blind processor 196 may include computer hardware and/or software, and the hardware and/or software may be secured by physical means (e.g., locks) and/or software means (e.g., passwords, passcodes) so that the access provider 104 cannot access the data stored within the double blind processor 196.

In one embodiment, the double blind processor 196 generates encrypted keys based on the received subscriber data from the access provider 104. In alternate embodiments, the double blind processor 196 performs data matching without using postal addresses. For example, in the case of a content provider such as a web portal (in place of the access provider 104), the subscriber data may include email addresses but not postal addresses, and the double blind processor 196 can access an additional data source or use data available within the double blind processor 196 that will enable matching with email addresses and/or names. The double blind process masks any P11 so the P11 is not used in subsequent operations. Encrypted keys may be generated by matching the names and addresses to a number of predefined IDs that correspond to those used in a marketing data appliance (MDA) 106. In one embodiment, the predefined IDs in the marketing data appliance are derived by an earlier application of the double-blind process to a database containing a portion of a consumer segment database, which replaces personally identifiable information with the predefined IDs. In one embodiment, the consumer segment database includes an INSOURCE^{SM} database. Returning to FIG. 2A, once the names and addresses from the subscriber data are matched to predefined IDs, the predefined IDs are then encrypted to create encrypted keys, and sent back to the access provider 104 at step A2. Embodiments may use encryption methods such as SHA1, MD5, PGP, GPG, etc. As such, any later matching processes are “double-blinded” as the matches are based on encrypted keys and not personally identifiable information. The keys are sent back so they can be used in subsequent operations to refer to the subscriber anonymously. In other words, the “double-blind” process is, first, matching consumer PII with a predefined ID that may be linked to one or more marketing segments of the consumer and, second, encrypting the predefined ID. In one embodiment, the predefined IDs are individual (I.e. unique) to a consumer/business.

Then the access provider forwards the encrypted keys at step A3 to the MDA 106. In one embodiment, once the MDA 106 receives the encrypted keys, at step A4 it performs a lookup in one or more consumer segment databases using the encrypted keys. In one embodiment, the INSOURCE^{SM} database is used as the consumer segment database. The MDA 106 can match the encrypted keys to one or more consumer segments that represent consumer attributes, such as attributes associated with the consumer and/or the consumer's household. The segments are stored in one embodiment with an associated key and an associated encrypted postal address. At step A5, the encrypted key and the one or more identified Consumer Segment IDs are sent to a Compute Cluster 110. The Compute Cluster 110 may include software processes to be applied to the data received. The Compute Cluster 110 may be configured to handle segment data lookup requests from a Real Time Marketing Bureau (RTMB) 102, which may be located outside of the access provider 104's firewall. The handling of segment lookup requests will be described in additional details in the section entitled “Real Time Operation” in conjunction with step B5 shown in FIG. 2A. In an optional step A6, the same encrypted key and the Consumer Segment ID(s) may be sent back to the access provider 104 so it could enhance its own marketing efforts. Although consumer segments and attributes are shown in this example and other examples, other segments and attributes can be used. For example, in some embodiments, segments and attributes for businesses can be used for business subscribers for certain access providers. In this manner, parties in business-to-business commerce may obtain data on businesses that may be customers or prospective customers.

In one embodiment, the operations performed at steps A1, A2, A3, A4, A5, and/or A6 are preferably conducted on a regularly scheduled basis, e.g., a daily or nightly basis, a twice daily basis, a weekly basis, etc. For example, subscriber UIDs or encrypted keys can be submitted on a nightly basis to the MDA 106, which in turns appends a corresponding Consumer Segment ID or other consumer data to the UIDs or encrypted keys and forwards the appended data to the RTMB 102. The access provider may also select a sub-set of subscriber data to send on a nightly basis (e.g., new subscribers) and send a more complete set of subscriber data on a weekly basis. Alternatively, the double blind process in steps A1 and A2 may be performed off-line and/or on a different schedule than steps A3-A6.

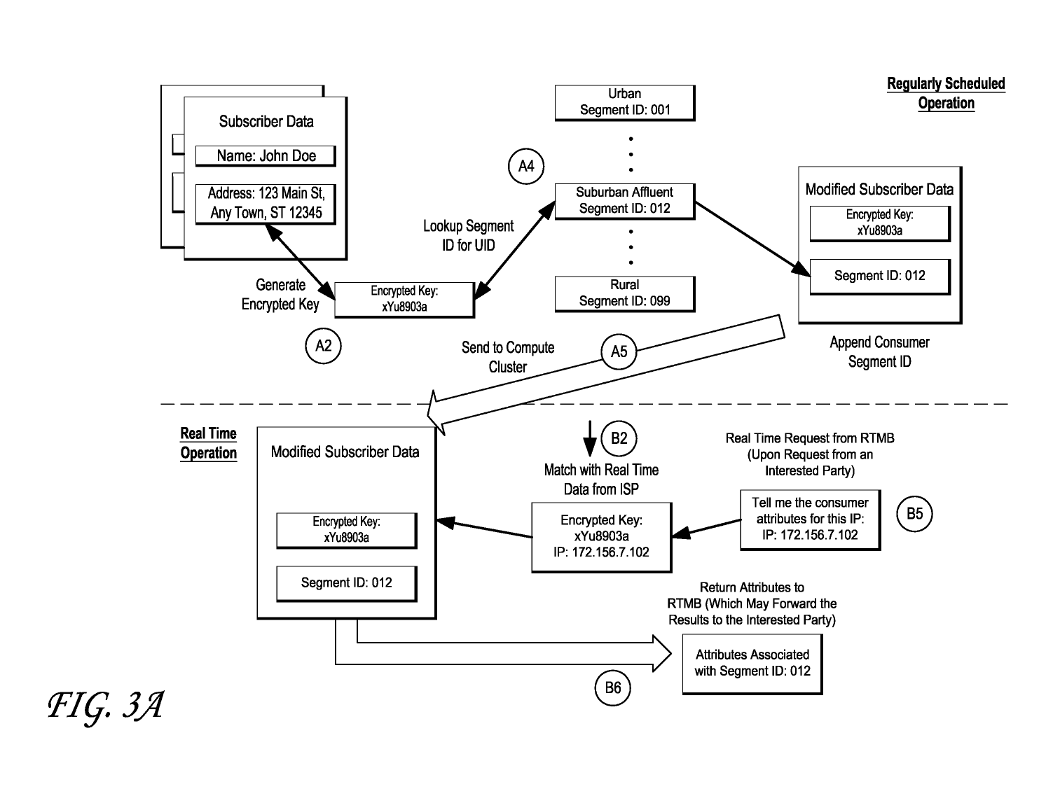

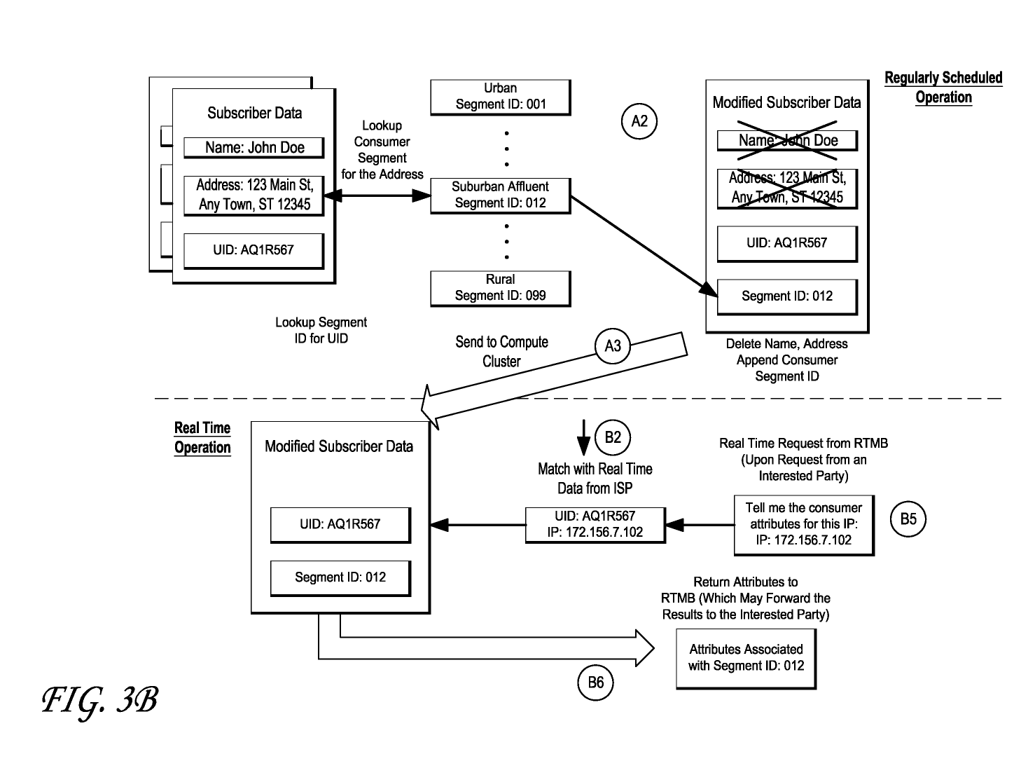

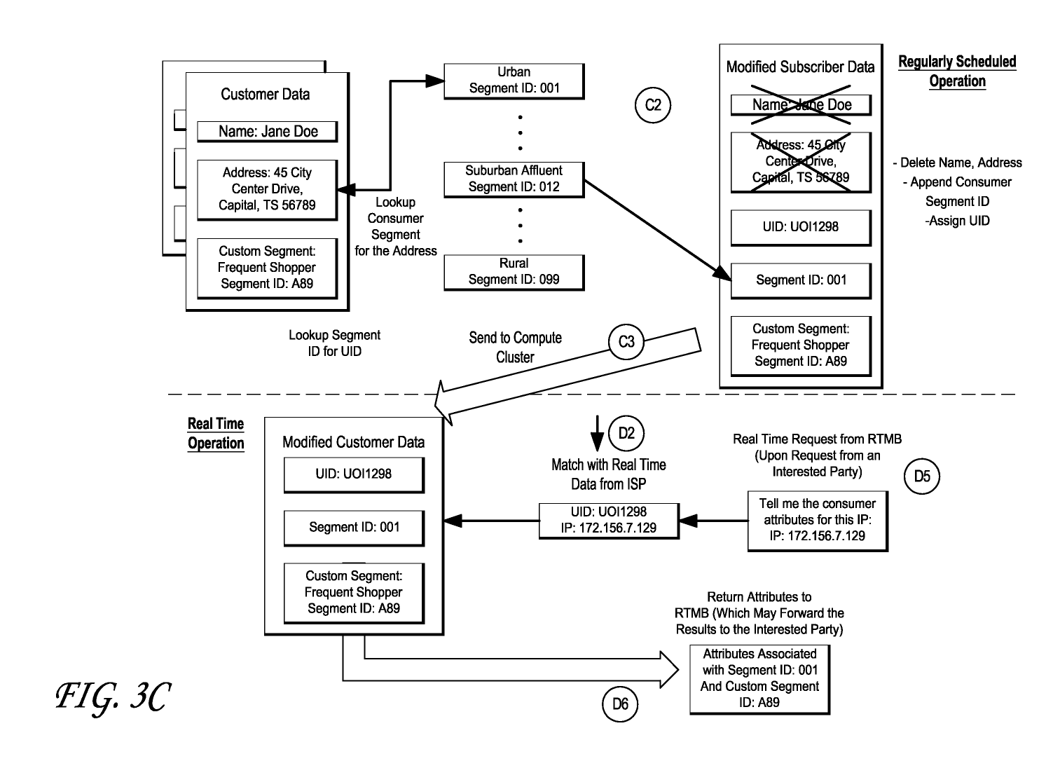

An illustrative data matching example is shown in FIG. 3A. After the double blind process returns an Encrypted Key, the Key is used to look up one or more matching consumer segment(s) or other consumer data. Although consumer data and segments are shown in the illustrative example, business data and segments may be used as well. An identifier of any matching segments (Consumer Segment ID(s)) or other consumer data may then be appended to the corresponding Encrypted Key to form Modified Subscriber Data, as illustrated in FIG. 3A. At step A5, the Encrypted Key and the one or more identified Consumer Segment IDs or other consumer data are sent to a Compute Cluster 110. The Compute Cluster 110 may include other software processes to be applied to the data received. The Compute Cluster 110 may be configured to handle data lookup requests from a Real Time Marketing Bureau (RTMB) 102, which may be located outside of the access provider 104's firewall.

Providing Marketing Information Based on Data Supplied by an Access Provider without Double Blind Processing

FIG. 2B is a combined block and flow diagram of a real time marketing system (RTMS) 200 according to another embodiment without the double blind processing. At step A1, the access provider 104 provides subscriber data to the MDA 106. Subscriber data may include, e.g., for each subscriber, the subscriber's name, the subscriber's address, a Unique ID (UID) assigned to the subscriber, or other PII of the subscriber. Subscriber data may also include attributes that the access provider contributes to the RTMB. The MDA 106 may be coupled to the same local area network as the access provider and behind a common firewall 108 as shown. In other embodiments, the MDA 106 may be coupled to a network outside of the access provider's network and the access provider 104 may transmit subscriber data to the MDA 106 over a secure connection. The MDA 106 may include computer hardware and/or software, and the hardware and/or software may be secured by physical means (e.g., locks) and/or software means (e.g., passwords, passcodes) so that the access provider cannot access the data stored within the MDA.

Once the MDA 106 receives the subscriber data, at step A2 it performs a lookup in one or more consumer databases that contain consumer segments and other consumer data, using the subscriber data. In one embodiment, the INSOURCE^{SM} database is used. In one embodiment, the MDA 106 can match the subscriber address to one or more consumer segments or other consumer data that represent consumer attributes, such as attributes associated with the consumer and/or the consumer's household. In other embodiments, consumer data other than consumer segments can be used. In other embodiments, business data and/or segments may be used. In one embodiment, the MDA 106 first standardizes the names and addresses into a standard format before performing the matching. In alternate embodiments, the MDA 106 performs data matching without using postal addresses. For example, in the case of a content provider such as a web portal (in place of the access provider 104), the subscriber data may include email addresses but not postal addresses, and the MDA 106 can access an additional data source or use data available within the MDA that will enable the MDA to use the email addresses and/or names for matching.

An illustrative data matching example is shown in FIG. 3B, which shows that the subscriber address is identified as belonging to a household that has a consumer segment of “suburban affluent.” Although consumer data and segments are shown in the illustrative example, business data and segments may be used as well. An identifier of any matching segments (e.g., Consumer Segment ID) or other consumer data may then be appended to the corresponding UID within the subscriber data to form Modified Subscriber Data, as illustrated in FIG. 3B. Also, the name and address obtained from the access provider may be deleted from the subscriber data (or simply not included in the Modified Subscriber Data) to protect consumer privacy. At step A3, the UID and the one or more identified Consumer Segment IDs (e.g., contained in the Modified Subscriber Data illustrated in Figured 3B) or other consumer data are sent to a Compute Cluster 110. Once data is transmitted to the Compute Cluster, the MDA 106 may erase any personally identifiable subscriber data from its system. The Compute Cluster 110 may include other software processes to be applied to the data received. The Compute Cluster 110 may be configured to handle data lookup requests from a Real Time Marketing Bureau (RTMB) 102, which may be located outside of the access provider 104's firewall. In an optional step A4, the same UID and the Consumer Segment ID or other consumer data may be sent back to the access provider 104 so it could enhance its own marketing efforts.

In one embodiment, the operations performed at steps A1, A2, A3, and/or A4 are preferably conducted on a regularly scheduled basis, e.g., a daily or nightly basis, a twice daily basis, a weekly basis, etc. For example, the subscriber data can be submitted on a nightly basis to the MDA 106, which in turns appends a corresponding Consumer Segment ID to the UID and forwards the appended data to the RTMB 102. The access provider may also select a sub-set of subscriber data to send on a nightly basis (e.g., new subscribers) and send a more complete set of subscriber data on a weekly basis.

### Real Time Operation

For both embodiments depicted in FIGS. 2A and 2B, once the collected data from the access provider are processed by the MDA 106 and submitted to the RTMB 102, the RTMB 102 takes a number of steps to provide real time or substantially real time marketing information to Internet marketers, content providers, and/or other interested parties. At step BI, a subscriber 142, who may be a subscriber of the access provider 104, visits a website 134 that may contain one or more advertisements. The subscriber may be a consumer user, a business user, or any other network user accessing online content or other content over a wide area network. At step B2, the access provider 104 may periodically send dynamically updated pairings of subscriber IP addresses and subscriber UIDs and/or Encrypted Keys to the Compute Cluster 110 via an IP address allocation server 112. In one embodiment, the IP address allocation server 112 may comprise a Remote Authentication Dial-In User Service (RADIUS) server, a Dynamic Host Configuration Protocol (DHCP) server, or another server that performs the function of allocating IP addresses. In one embodiment, the data may be provided by a computer that provides deep packet inspection services for the access provider's network. In one embodiment, the pairings are sent at intervals, such as in one or two-minute intervals. At or around the same time, at step B3, the advertisement embedded within the site 134 or the site content itself may trigger a request to an interested party entity 130 who may have control over advertising content of the site 134, e.g., an advertiser (server) 122, an ad network (server) 124, a publisher (server) 126, or a web site (e.g., operated by a retailer) 128. The request may contain the consumer's IP address. The interested party entity 130 may then send the RTMB 102 a request for consumer data attributes along with the consumer's IP address at step B4.

At step B5, the RTMB 102 in turn may route the request to the proper Compute Cluster 110. Since multiple access providers may partner with the RTMB 102 to supply marketing data, the RTMB 102 is responsible for determining the proper Compute Cluster 110 by matching the incoming IP address with the IP address range handled by the Compute Cluster 110 associated with each access provider. For example, a Compute Cluster “A” may be installed at an access provider “A” with a first IP address range while a Compute Cluster “B” may be installed at an access provider “B” with a second IP address range. When an incoming request arrives, the RTMB may find that the IP address associated with the request is within the second IP address range. The RTMB may recognize that the IP address is from a subscriber of access provider “B” and thus forward the request to the Compute Cluster “B.” The Compute Cluster 110 may look up the consumer data attributes as follows.

With reference again to FIG. 3A, first, the Compute Cluster 110 tries to find the Encrypted Key associated with the incoming consumer's IP address. In one embodiment, the Encrypted Key may be found by looking up the Encrypted Key and IP address pairing supplied by the access provider 104 in real time or substantially real time (at step B2).

In the example shown in FIG. 3A, the IP address “172.156.7.102” is matched with an Encrypted Key of “xYu8903a” according to the real time data provided by the access provider. Second, the Compute Cluster 110 tries to find the Consumer Segment ID or other consumer data using the Encrypted Key. The Consumer Segment ID or other consumer data may be located by matching previously received data from the MDA 106. In the example shown in FIG. 3A, the Encrypted Key of “xYu8903a” is matched with the Consumer Segment ID “012,” which may represent a consumer segment such as “Suburban Shopper.” Third, once the Consumer Segment ID is located, the Compute Cluster 110 may retrieve one or more data attributes associated with the Consumer Segment ID, and return the data attributes to the RTMB 102 at step B6. In other embodiments multiple Consumer Segment IDs may be located. The RTMB 102 may then forward the returned data attributes to the interested party entity 130 at step B7. In other embodiments, the RTMB 102 may simply return the Consumer Segment ID to the interested party and allow the interested party to associate the Consumer Segment ID with one or more consumer attributes. In other embodiments multiple Consumer Segment IDs may be returned by the RTMB 102.

FIG. 3B depicts a similar real time matching process for the embodiment shown in FIG. 2B, which does not employ Encrypted Keys but instead uses UIDs. In this embodiment, UIDs are used to match the appropriate Consumer Segment IDs or other consumer data. In this embodiment, at step B2 the access provider forwards IP address and UID pairings to the Compute Cluster.

If the interested party entity is an advertiser (server) 122 or an ad network (server) 124, it may then select an advertisement based on the returned data attributes and serve the advertisement to the site 134 at step B8 in FIG. 2B. In other embodiments, customized content is returned at step B8 where the interested party entity 130 is a publisher (server) 126 or a web site (e.g., operated by a retailer) 128. For example, the site 134 may be a site owned by a credit card company. If the credit card company finds out from the returned data attributes that the subscriber 142 is an avid traveler, it may display on the landing page of the site an offer for a travel rewards credit card. In other examples, the publisher (server) 126 may simply wish to tailor the content of the site 134 to display images that may match the likely profile of the subscriber 142, or otherwise display site content related to the consumer's likely geography or demographic attributes.

In other embodiments, the RTMB 102 may not be provided with the IP address and UID pairing collected by the access provider. For example, the subscriber 142 may not be a subscriber of an access provider that has an arrangement to send data to the RTMB 102. In such cases, the RTMB 102, given an IP address supplied by an interested party entity 130, may nevertheless return consumer or business related attributes based on (1) estimating a geography for the IP address and (2) returning consumer or business related attributes associated with the estimated geography, for example. The process of performing geo-location lookup is further described in co-pending U.S. patent application entitled “SYSTEMS AND METHODS FOR REAL TIME SEGMENTATION OF CONSUMERS,” Ser. No. 12/118,585, filed May 9, 2008, the disclosures of which are hereby fully incorporated by reference. In another embodiment, when the RTMB 102 does receive an actual IP address and UID pairing from the access provider 104, it provides feedback to the geo-location process so it can improve its ability to estimate geography and find matching consumer or business related attributes.

Consumer privacy is maintained in various embodiments as the Compute Cluster returns only the consumer or business related attributes associated with the IP address to the RTMB. With reference to FIGS. 2A and 2B, at step B7, the RTMB 102 may return to the interested party entity 130 attributes received directly from the Compute Cluster. In one or more embodiments, the Compute Cluster does not send to the RTMB any ID (such as user/household ID or subscriber ID), does not return to the RTMB the IP address that is submitted by the RTMB, and/or does not send to the RTMB any pairings of IP addresses and subscriber IDs. As such, no personally identifiable data is sent outside of the access provider's firewall.

### Providing Marketing Information Based on Data Supplied by a Business

In the embodiment of FIG. 2C, a sample temporal flow of data is indicated by the circled numerals C1-C4 and D1-D8 and is described in further detail below. Depending on the embodiment, certain steps may be removed and additional steps may be added. FIG. 2C is a combined block and flow diagram of a real time marketing system (RTMS) 300 according to another embodiment in which data is provided by a business. A business may wish to supply customer data to the RTMS 300 so that when its customers are on-line, the business may direct associated Internet advertisers, content providers, or other parties to serve targeted ads or customized content to those customers based on the consumer or business related data attributes provided by the RTMS and the business' own knowledge about its customers stored in the form of custom segments. As used herein, a “business” may refer to a physical business or an online business.

In one example, the business that is supplying customer data may direct ads in order to “up sell” a product. For example, a car manufacturer may already know that a certain customer A is interested in or otherwise owns a mid-priced model, and the car manufacturer may wish to direct to customer A an advertisement touting a luxury model. In another example, an electronic retailer may “cross sell” a product by directing to a customer who has recently purchased a high-definition TV advertisements that feature a number of accessories such as a digital video recorder. Finally, a business may wish to initiate “competitive blocking,” so that it can buy advertising inventory for its customers so as to not allow its competitors to buy that same advertising inventory or reach those same customers in the online advertisements in question. Finally, if the customer visits a site controlled by the business, the business may use the returned consumer or business related data attributes to customize content to be displayed to the customer.

Returning to FIG. 2C, at step C1, a business 114 provides customer data to a Marketing Data Appliance (MDA) 116. Customer data may include names, addresses, usernames, email addresses, and/or custom segments or other consumer or business related data. A custom segment contains consumer or business related data attributes that are custom made for consumer or business customers of the particular business. For example, a business may classify a customer as a frequent shopper based on its internal sales data. The MDA 116 may be located within the same local area network (e.g., a secured LAN) as the business 114 or behind a common firewall 118 as shown. In other embodiments, the MDA 116 may be located outside of the business' network and the business 114 may transmit subscriber data to the MDA 116 over a secure connection. The MDA 116 may include computer hardware and/or software, and the hardware and/or software may be secured by physical means (e.g., locks) and/or software means (e.g., passwords, passcodes) so that the business cannot access the data stored within the MDA.

Once the MDA 116 receives the subscriber data, it may perform several tasks at step C2. An illustrative example is provided in FIG. 3C. First, the MDA 116 performs a lookup in a consumer database using the customer data. In one embodiment, the INSOURCE^{SM} database is used. For example, as shown in FIG. 3C, the customer's address is identified as belonging to a household that has a consumer segment of “urban affluent.” Second, for each customer entry, the MDA may append the located Consumer Segment ID, assign a UID, and delete the name and the address to protect consumer privacy. At step C3, the UID, the Consumer Segment ID or other consumer data, and/or the Custom Segment ID are sent to a Compute Cluster 110. Once data is transmitted to the Compute Cluster, the MDA 116 may erase any personally identifiable subscriber data from its system. The Compute Cluster 110 may include software processes to be applied to data received from the business 114. The Compute Cluster 110 may be configured to handle data lookup requests from a Real time Marketing Bureau (RTMB) 102. In an optional step C4, the UID and the Consumer Segment ID or other consumer data may be sent back to the business 114 so it could enhance its own marketing efforts. In alternate embodiments, the MDA 116 performs data matching without using names and addresses. For example, the customer data may include email addresses but not postal addresses, and the MDA 116 can access an additional data source or use data available within the MDA that will enable the MDA 116 to use the email addresses and/or names for matching.

In one embodiment, the operations performed at steps C1, C2, C3, and/or C4 are preferably conducted on a regularly scheduled basis, e.g., a daily or nightly basis, a twice daily basis, a weekly basis, etc. Also, the business may select a sub-set of customer data to send on a nightly basis (e.g., new customers) and send a more complete set of customer data on a weekly basis.

### Real Time Operation

Once the collected data from the business are processed by the MDA 116 and submitted to the RTMB 102, the RTMB 102 may take a number of steps to provide real time or substantially real time marketing information to marketers, content providers, and/or other interested parties. At step D1, a customer 144, who may be a subscriber of the access provider 104, visits a website 134 that may contain one or more advertisements. At step D2, the access provider 104 may periodically send dynamically updated pairing of the customer's current IP address and the customer's UID to the Compute Cluster 110 via an IP address allocation server 112. In one embodiment, the IP address allocation server 112 may comprise a RADIUS server, a DHCP server, or another server that performs the function of allocating IP addresses. In one embodiment, the pairings are sent in one or two-minute intervals. At or around the same time, at step D3, one or more advertisements embedded within the site or the site content itself may trigger a request to an interested party entity 130 who may have control over one or more advertisements or some or all of the content on the site 134, e.g., an advertiser (server) 122, an ad network (server) 124, a publisher (server) 126, or a web site (e.g., operated a retailer) 128. The request may contain the customer's IP address. The interested party entity may then send the RTMB 102 a request for consumer data attributes along with the customer's IP address at step D4.

At step D5, the RTMB 102 in turn may route the request to the proper Compute Cluster 110. Since multiple access providers may partner with the RTMB 102 to supply marketing data, the RTMB 102 is responsible for determining the proper Compute Cluster 110 by matching the incoming IP address with the IP address range handled by the Compute Cluster 110 associated with each access provider. With reference again to FIG. 3C, the Compute Cluster 110 looks up the consumer segment as follows. First, the Compute Cluster 110 tries to find the UID associated with the incoming IP address. The UID is found by looking up the UID and IP address pairing supplied by the access provider 104 in real time or substantially real time (at step D2). In the example shown in FIG. 3C, the IP address “172.156.7.129” is matched with a UID of “UOI1298” according to the real time data provided by the access provider. Second, the Compute Cluster 110 tries to find the Consumer Segment ID and Custom Segment ID using the UID. The Consumer Segment ID and the Custom Segment ID are located by matching previously received data from the MDA 116 (at step C3). In the example shown in FIG. 3C, the UID of “UOI1298” is matched with the Consumer Segment ID “001” and Custom Segment ID “A89.” Third, once the Consumer Segment ID and Custom Segment ID are located, the Compute Cluster 110 then retrieves a number of data attributes associated with the Consumer Segment ID and Custom Segment ID, and then returns the data attributes to the RTMB 102 at step D6. The RTMB 102 may then forward the results to the interested party at step D7. As described above, the interested party entity 130 at step D8 may then return to the site 134 a selected advertisement or customized content based on the returned data attributes (e.g., up-selling or cross-selling advertisements, competitive blocking, etc.).

As described above in conjunction with FIGS. 2A and 2B, in other embodiments, the RTMB 102 may not be provided with the IP address and UID pairing collected by the access provider and may return consumer attributes based on (1) estimating a geography for the IP address and (2) returning consumer attributes associated with the estimated geography.

### Example System Implementation

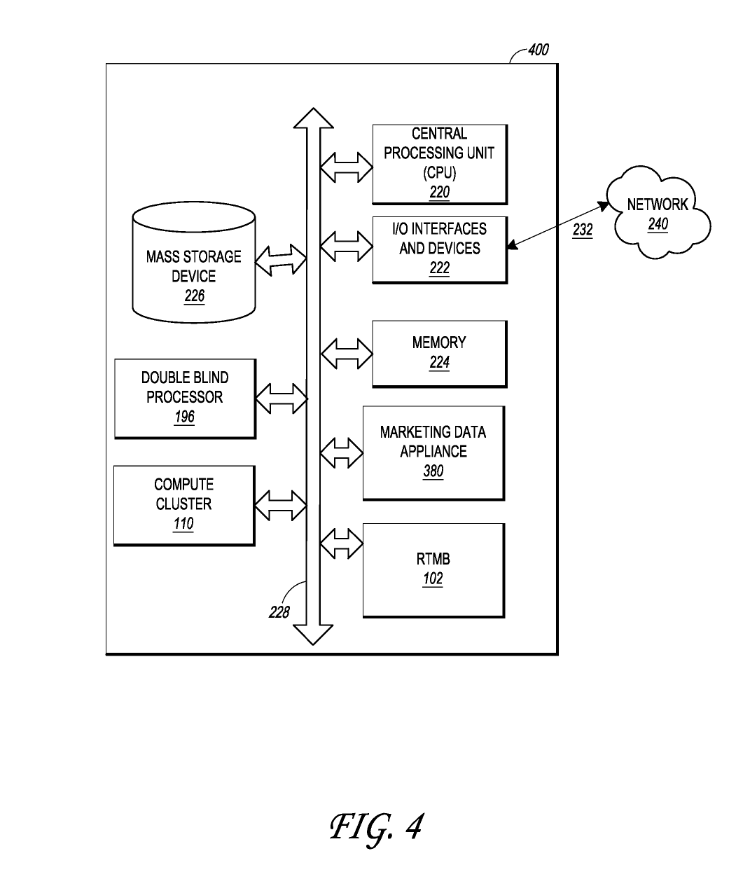

FIG. 4 is a block diagram illustrating an anonymized marketing system 400 in accordance with one embodiment. The anonymized marketing system 400 may include, for example, one or more servers and/or personal computers that are IBM, Macintosh, or Linux/Unix compatible. In one embodiment, the anonymized marketing system 400 comprises one or more servers, desktop computers, laptop computers, personal digital assistants, kiosks, or mobile devices, for example. In one embodiment, the anonymized marketing system 400 includes at least one central processing unit (“CPU”) 220, which may include one or more conventional microprocessors. The anonymized marketing system 400 may further include a memory 224, such as random access memory (“RAM”) for temporary storage of information and a read only memory (“ROM”) for permanent storage of information, and a mass storage device 226, such as a flash drive, a hard drive, a diskette, or an optical media storage device. In one embodiment, the mass storage device may be used to store consumer segment data as described above. Typically, the components and modules of the anonymized marketing system 400 are connected to the computer using a standard based bus system. In different embodiments, a standard based bus system 228 could be Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of the anonymized marketing system 400 may be combined into fewer components and modules or further separated into additional components and modules.

The anonymized marketing system 400 is generally controlled and coordinated by operating system software, such as Windows Server, Linux Server, Windows NT, Windows 2000, Windows XP, Windows Vista, Windows 7, Unix, Linux, SunOS, Solaris, or other compatible server or desktop operating systems. In Macintosh systems, the operating system may be any available operating system, such as MAC OS X. In other embodiments, the anonymized marketing system 400 may be controlled by a proprietary operating system. Conventional operating systems control and schedule computer processes for execution, perform memory management, provide file system, networking, I/O services, and provide a user interface, such as a graphical user interface (“GUI”), among other things.

The anonymized marketing system 400 may include one or more commonly available input/output (I/O) devices and interfaces 222, such as a keyboard, mouse, touchpad, and printer. In one embodiment, the I/O devices and interfaces 222 include one or more display devices, such as a monitor, that allows the visual presentation of data to a user. More particularly, a display device provides for the presentation of GUIs, application software data, and multimedia presentations, for example. The anonymized marketing system 400 may also include one or more multimedia devices 230, such as speakers, video cards, graphics accelerators, and microphones, for example. In other embodiments, such as when the anonymized marketing system 400 comprises a network server, for example, the anonymized marketing system 400 may not include any of the above-noted man-machine I/O devices.

As shown in FIG. 4, the I/O devices and interfaces 222 may provide a communication interface to various external devices. In the embodiment of FIG. 4, the anonymized marketing system 400 is electronically coupled to a network 240, via a wired, wireless, or combination of wired and wireless, communication link 232. The network 240 may comprise one or more of a LAN, WAN, and/or the Internet, for example. The network 240 may facilitate communications among various computing devices and/or other electronic devices via wired or wireless communication links.

Data requests may be sent to the anonymized marketing system 400 over the network 240. Similarly, results may be returned over the network 240. In addition to the devices that are illustrated in FIG. 4, the anonymized marketing system 400 may communicate with other data sources or other computing devices. In addition, the data sources may include one or more internal and/or external data sources. In some embodiments, one or more of the databases, data repositories, or data sources may be implemented using a relational database, such as Sybase, Oracle, CodeBase and Microsoft SQL Server as well as other types of databases such as, for example, a flat file database, an entity-relationship database, and object-oriented database, and/or a record-based database. In one embodiment, the data sources may include data storage for consumer marketing segment data as described above.

In the embodiment of FIG. 4, the anonymized marketing system 400 also includes a number of components/modules that may be executed by the CPU 220. As shown, they include one or more of the following: the double blind processor 196, the compute cluster 110, and the real time marketing bureau 102. These modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Alternately, each of these modules may be implemented as separate devices or systems, such as computer servers. The modules may be combined into fewer modules and/or split into additional modules while performing the same functionalities.

In general, the word “module,” as used herein, refers to logic embodied in hardware or firmware, or to a collection of software instructions, possibly having entry and exit points, written in a programming language, such as, for example, Java, Lua, C, C++, or C#. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware and stored in memory such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

### CONCLUSION

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A system for providing anonymized marketing data, comprising:
a segment data store comprising marketing data segment records associated with a plurality of subscribers of an access provider;
a marketing data appliance that is configured to receive a plurality of encrypted keys created from personally identifiable information of the plurality of subscribers and append, to the encrypted keys, one or more consumer segment identifiers for the marketing data segment records associated with the individual subscriber; and
a compute cluster system that is configured to:
receive the encrypted keys with the appended consumer segment identifiers from the marketing data appliance;
receive from a network address allocation server a plurality of data entries indicating network addresses assigned to the subscribers; and
return, upon a data request from a bureau server containing a network address of a subscriber accessing a server via the access provider, one or more marketing data segment records from the segment data store to the bureau server.

2. The system of claim 1, further comprising:
a processer that is configured to generate the encrypted keys by at least:
receiving personally identifiable information of the plurality of subscribers from the access provider;
for one or more of the plurality of subscribers, matching the personally identifiable information of an individual subscriber to an identifier previously associated with the personally identifiable information, the identifier useable to access data that are associated with the individual subscriber in the segment data store;
creating the encrypted keys based on the matched identifiers; and
deleting the received personally identifiable information.

3. The system of claim 2, wherein the identifier is associated with the personally identifiable information of the individual subscriber by a double-blind processor prior to the processor receiving the personally identifiable information of the plurality of subscribers from the access provider.

4. The system of claim 1 wherein the data entries include entries pairing the encrypted keys to network addresses assigned to the subscribers by the access provider.

5. The system of claim 4 wherein the compute cluster system is configured to return the marketing data segment records by at least:
using the network address in the data request from the bureau server to locate, from the data entries of pairings, an encrypted key associated with the network address; and
using the one or more consumer segment identifiers appended to the encrypted key to access marketing data segment records associated with the appended consumer segment identifiers.

6. The system of claim 1 wherein the bureau server is configured to, upon receiving the one or more marketing data segment records, return the one or more marketing data segment records associated with the subscriber to a requesting entity.

7. The system of claim 6 wherein the requesting entity is configured to customize content in a website visited by the subscriber based on the one or more returned marketing data segment records.

8. The system of claim 7 wherein the customized content comprises an advertisement.

9. The system of claim 6, wherein the requesting entity includes an advertising network server, a publisher site server, or an advertiser server.

10. The system of claim 1, wherein the bureau server is configured to route requests to an appropriate marketing data appliance associated with an access provider based on a network address received from a requesting entity.

11. The system of claim 1, wherein the marketing data appliance is further configured to return to the access provider the encrypted keys with the appended consumer segment identifiers.

12. The system of claim 1, wherein the personally identifiable information comprises a name, an address and a subscriber identifier.

13. The system of claim 1, wherein the marketing data appliance and the compute cluster system are located within a network that is maintained by an access provider to which the plurality of subscribers belong.

14. The system of claim 1, wherein the marketing data appliance is further configured to generate the encrypted keys by at least:
receiving personally identifiable information of the plurality of subscribers from the access provider;
for one or more of the subscribers, matching the personally identifiable information of an individual subscriber to an identifier associated with the personally identifiable information;
creating an encrypted key based on the matched identifier; and
deleting the received personally identifiable information.

15. A computer-implemented method of providing anonymized marketing data, comprising:
receiving personally identifiable information for a plurality of subscribers from a network access provider;
returning to the network access provider a plurality of encrypted keys that correspond to the received personally identifiable information, the encrypted keys useable to access data in a segment data store;
receiving the returned encrypted keys at a marketing data appliance;
for each of the encrypted keys, appending to the encrypted key one or more consumer segment identifiers in the segment data store that match the encrypted key; and
forwarding the encrypted keys and the appended consumer segment identifiers to a compute cluster system, the compute cluster system configured to return a plurality of marketing data attributes associated with the consumer segment identifiers in response to a request for the marketing data attributes,
wherein the method is executed on one or more computing systems.

16. The computer-implemented method of claim 15, wherein the returning to the network access provider the encrypted keys that correspond to the received personally identifiable information further comprises:
for each subscriber, matching the received personally identifiable information to an identifier that corresponds to the personally identifiable information; and
encrypting the identifier to create an encrypted key for the subscriber.

17. The computer-implemented method of claim 16, wherein the personally identifiable information comprises a name, an address and a subscriber identifier.

18. The computer-implemented method of claim 16, wherein the identifier is previously assigned by a double-blind processor to the subscriber based on the personally identifiable information.

19. The computer-implemented method of claim 15, wherein the forwarding further comprises:
receiving, at a marketing bureau server, the request for the marketing data attributes, the request comprising a network address of the subscriber;
identifying a proper compute cluster system for the network address; and
sending the request to the identified compute cluster system.

20. The computer-implemented method of claim 19, wherein the forwarding further comprises:
receiving from a network address allocation server a plurality of data entries pairing the encrypted keys to network addresses assigned to the subscribers;
using the network address of the request to locate, from among the plurality of data entries, an associated encrypted key; and
using the consumer segment identifiers appended to the associated encrypted key to retrieve the associated marketing data attributes.

21. The computer-implemented method of claim 19, wherein the marketing data appliance and the compute cluster system are located within a network maintained by the network access provider behind one or more common firewalls.

22. The computer-implemented method of claim 15 further comprising:
returning the appended consumer segment identifiers of the subscribers to the access provider.

23. The computer-implemented method of claim 15, wherein the forwarding further comprises returning a plurality of marketing data attributes associated with the consumer segment identifiers when the subscriber is accessing, through the network service provider, a server that triggers a request for the marketing data attributes, the server including an advertising network server, a publisher site server, or an advertiser server.

24. A system for providing anonymized marketing data, comprising:
a segment data store comprising marketing data segment records associated with a plurality of customers of a business entity;
a marketing data appliance that is configured to:
receive personally identifiable information of the plurality of customers from the business entity;
for one or more of the customers, match personally identifiable information of an individual customer to an identifier, the identifier useable to access data in the segment data store; and
append to the identifier one or more consumer segment identifiers for the marketing data segment records associated with the individual customer; and
a compute cluster system that is configured to:
receive the identifiers with the appended consumer segment identifiers from the marketing data appliance;
receive from a network address allocation server a plurality of data entries indicating network addresses that are assigned to the customers who are subscribers of an access provider; and
return, upon a data request from a bureau server comprising a network address, one or more marketing data segment records from the segment data store to the bureau server.

25. The system of claim 24 wherein the data entries are dynamically updated.

26. The system of claim 24 wherein the data entries comprise entries indicating pairings of identifiers to network addresses assigned to subscribers of the access provider.

27. The system of claim 26 wherein the compute cluster system is configured to return the marketing data segment records by at least:
using the network address in the request from the bureau server to locate, from the data entries of pairings, an associated identifier; and
access the marketing data segment records with the one or more associated consumer segment identifiers appended to the located identifier.

28. The system of claim 24 wherein the marketing data segment records further comprise custom marketing data segments records provided by the business entity.

29. A computer-implemented method of providing anonymized marketing data, comprising:
receiving personally identifiable information for a plurality of customers from a business entity;
for one or more of the plurality of customers, assigning an identifier to an individual customer and appending to the identifier one or more consumer segment identifiers that are associated with the identifier;
forwarding the identifiers and the appended consumer segment identifiers to a compute cluster system, the compute cluster system configured to receive network address assignments of the customers from a network access provider; and
returning, by the compute cluster system, a plurality of marketing data attributes associated with the consumer segment identifiers when at least one of the customers is accessing, through the network access provider, a server that triggers a request for the marketing data attributes,
wherein the method is executed on one or more computing systems.

30. The computer-implemented method of claim 29, wherein the returning further comprises:
receiving from the network address allocation server a plurality of data entries pairing the identifiers to network addresses assigned to the customers by the network access provider;
using the network address of the request to locate, from among the data entries, an identifier associated with the network address of the request; and
using the consumer segment identifiers appended to the located identifier to retrieve the associated marketing data attributes.

31. The computer-implemented method of claim 29, wherein the personally identifiable information comprises a name and an address.

32. The computer-implemented method of claim 29, further comprising:
receiving, from the business entity, custom marketing data attributes associated with the customers of the business entity.
